(19) United States
(12) Patent Application Publication
(10) Pub. No.: US 2017/0106842 A1
(43) Pub. Date: Apr. 20, 2017

(54) Damping Device and Slip-Controllable Vehicle Brake System

(71) Applicant: Robert Bosch GmbH, Stuttgart (DE)

(72) Inventors: Bernd HAEUSSER, Neckawestheim (DE); Oliver GAERTNER, Abstatt (DE); Horst BELING, Heilbronn (DE); Oliver HENNING, Obersulm (DE); Michael SCHUESSLER, Seckach (DE)

(21) Appl. No.: 15/301,526

(22) PCT Filed: Feb. 3, 2015
(86) PCT No.: PCT/EP2015/052196

§ 371 Date: Oct. 3, 2016

(30) Foreign Application Priority Data
Apr. 3, 2014 (DE) 10 2014 206 401.5

(51) Int. Cl. B60T 8/40; B60T 13/14; B60T 13/68; B60T 8/48

(52) U.S. Cl. CPC B60T 8/4068; B60T 8/4872; B60T 13/146; B60T 13/686

(57) ABSTRACT

A damping device includes a structure that defines an inlet and an outlet configured to supply pressure medium to the damping device, a first pressure chamber connected to the inlet and to the outlet, a second pressure chamber configured to receive a compressible medium, and a third pressure chamber having a pressure level. The damping device further includes a separating device and a pressure-medium connection. The separating device is positioned between the first pressure chamber and the second pressure chamber, and is configured to separate the third pressure chamber and the second pressure chamber and enable pressurization of the second pressure chamber with the pressure level of the third pressure chamber. The pressure-medium connection has an integral resistance and connects the first pressure chamber to the third pressure chamber.

### PRIOR ART

The invention concerns a damping device with the features of the preamble of claim 1, and a slip-controllable vehicle brake system with the features of claim 8.

Damping devices are used in particular in slip-controllable vehicle brake systems to reduce the noise caused by pressure pulsations. Pressure pulsations occur for example in piston pumps which are actuated as required in order, together with other actuators of the vehicle brake system, to adapt the brake pressure of a wheel brake to the slip conditions of a wheel assigned to the wheel brake. The piston pumps perform suction and delivery strokes in a cyclic alternation, which trigger delivery flow or pressure pulsations in the brake circuits of the vehicle brake system and can cause disruptive operating noise.

Damping devices are ideally arranged in the immediate physical vicinity of the site of generation of the pressure pulses, e.g. close to a pump outlet or an outlet valve of a piston pump. In particularly compact solutions, the damping devices are accommodated together with their assigned piston pumps in common receiver bores of a hydraulic block of a hydraulic assembly. Such damping devices are disclosed for example in DE 101 12 618 A1.

Many of these indicated variants use an elastically deformable membrane which seals a fluid-filled first pressure chamber from a gas-filled second pressure chamber. When pressure pulsations occur, the membrane deflects towards the pressure chamber filled with compressible gas, so that the volume of the fluid-filled pressure chamber expands and smooths out the pulsations.

Downstream of the fluid-filled pressure chamber, a choke is provided as a hydraulic resistance for the outflowing fluid.

The first pressure chamber with the variable storage capacity forms a so-called C-member, downstream of which the hydraulic resistance—also called the R-member—is connected. The R-member may be formed as a constant choke or as a dynamic choke which provides a pressure-dependently variable resistance.

A dynamic choke has the advantage that it provides a strong choke effect and hence a high noise damping at low pressures (approximately 40 bar) which are typical for example of comfort functions, e.g. cruise control, whereas at pressures above around 40 bar, such as occur mainly in safety-relevant functions such as anti-lock braking or traction control processes, they allow a high flow or offer a low flow resistance.

The lower the resistance of the choke, the lower the drive power required for pump actuation and vice versa. The effective pressure range of the damping device is therefore limited by the maximum power of the drive and the maximum storage capacity of the damping device. The latter is determined substantially by restrictions in the installation space of the hydraulic block.

The disadvantage of the known solutions is that the damping properties of the damping devices are dependent on the momentary system pressure of the connected brake system.

If this system pressure is higher than the pressure taken as the design basis for the membrane and its installation space, the membrane hits a mechanical stop and any pressure pulsations occurring can cause no further deflection of the membrane, and hence can no longer be damped.

If however the system pressure is significantly lower than the design pressure of the damping device, the membrane behaves too stiffly to be able to damp pulsations occurring in the low-pressure range.

### Advantages of the Invention

Against this technical background, a damping device is proposed which acts largely independently of the prevailing operating pressure.

Damping devices according to the features of claim 1 behave independently of operating pressure and show almost constant damping properties over the entire pressure range of the system pressure. They are furthermore distinguished in that they have no negative influence on the pressure build-up dynamic of the vehicle brake system because they themselves hold little pressure medium, i.e. they have a low absorption volume. Despite particularly effective damping, in particular in the low-pressure range of the vehicle brake system, it remains possible to deliver relatively large volumes of pressure medium and hence build up pressure rapidly in the case of unexpected emergency braking, e.g. for collision avoidance or pedestrian protection.

For this, a damping device according to the invention comprises, in addition to the two existing pressure chambers, a third pressure chamber which is coupled to the first fluid-filled pressure chamber via a fluidic connection equipped with a hydraulic resistance. The separating device separates the third pressure chamber from the second pressure chamber but nonetheless allows the second pressure chamber to be pressurized with the pressure level of the third pressure chamber.

This configuration allows the second pressure chamber filled with compressible medium to be pressurized with the fluid pressure in pressure chambers one and three, and hence with the momentary system pressure. The separating device is equipped with a membrane which can assume a neutral position independently of the level of the momentary system pressure, so that the membrane has almost the entire mechanical deflection available for damping pressure pulsations. In structural terms, this deflection is delimited by end stops against which the membrane may rest if the pressure rises above or falls below a specific pressure level. Via the end stops and via the preload pressure in the second pressure chamber, the pulsation-induced membrane deflection and hence the maximum absorption of brake fluid by the damping device can be limited, or the pressure range can be established within which damping takes place or outside which the effect of the damping device diminishes.

Exemplary embodiments of the invention are depicted in the drawings and explained in detail in the description which follows.

The drawings show:

FIG. 1: a diagrammatic depiction of a single-stage damping device configured according to the invention;

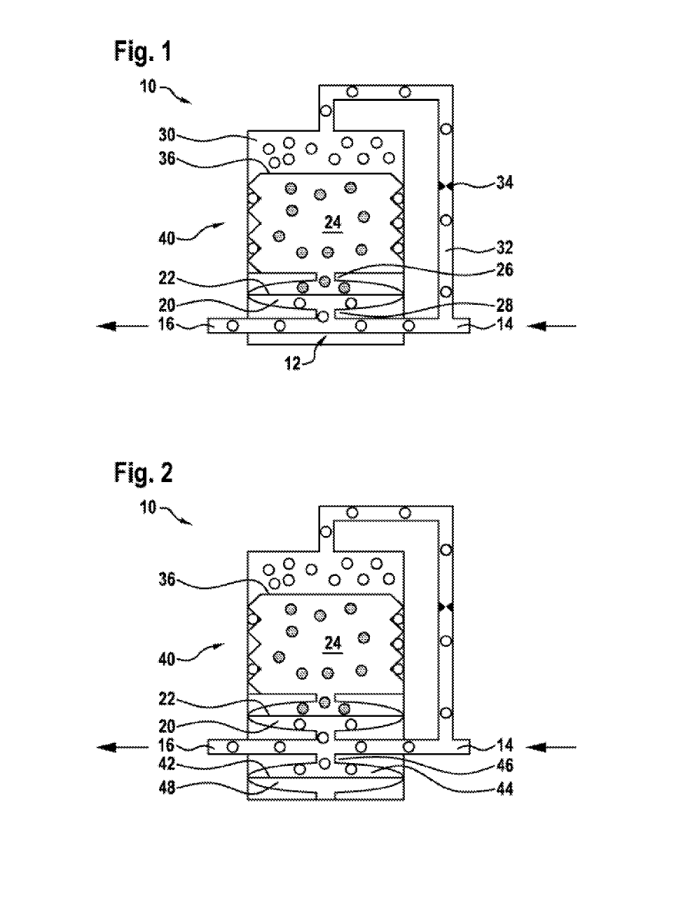

FIG. 2: also diagrammatically, an exemplary embodiment of a two-stage damping device;

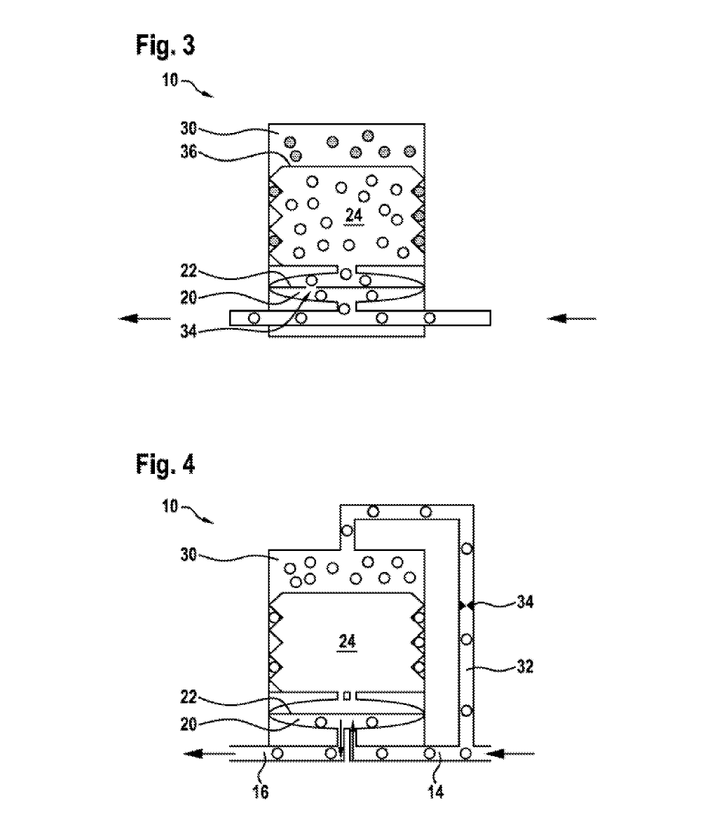

FIG. 3: an alternative embodiment variant of a single-stage damping device; and

FIG. 4: a further exemplary embodiment of a single-stage damping device;

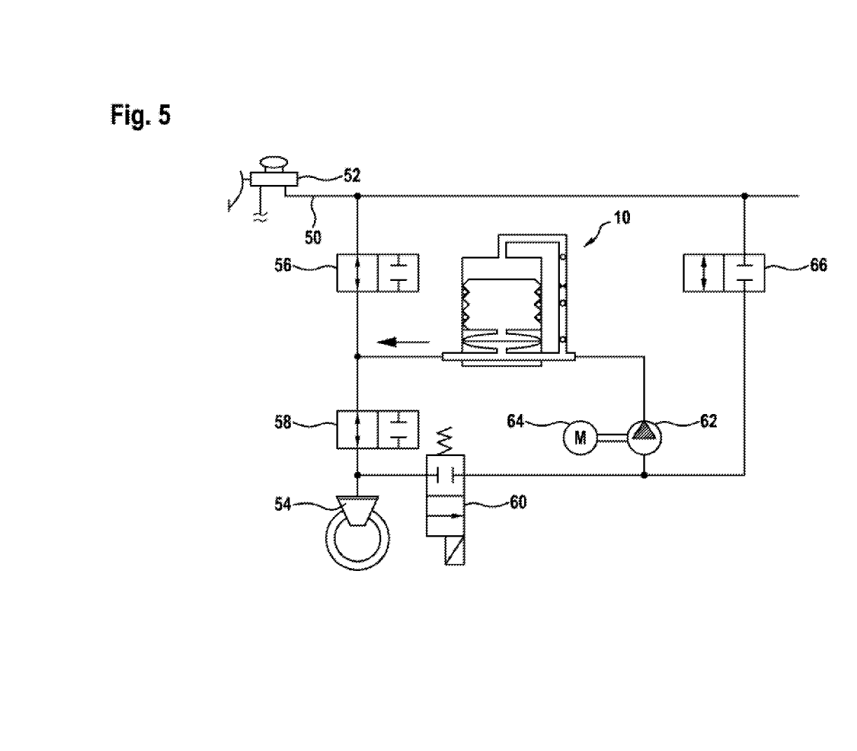

FIG. 5: a brake circuit depicted using a hydraulic circuit diagram, with the damping device proposed.

### DISCLOSURE OF THE INVENTION

FIG. 1 shows a first exemplary embodiment of a damping device 10 according to the invention. This is connected to a line 12 carrying brake fluid, which forms an inlet upstream of the damping device 10 and an outlet 16 downstream of the damping device. Inflowing brake fluid from the line 12 first enters a first pressure chamber 20 which is separated from the second pressure chamber 24 by an elastically deformable membrane 22. The second pressure chamber 24 is filled with a compressible medium, preferably a gas, wherein this gas is under a preload pressure which preloads the membrane 22. A deflection of this membrane 22 is restricted in both spatial directions by mechanical stops 26, 28 which are respectively formed in one of the two pressure chambers 20, 24. If a pressure difference between the two pressure chambers 20, 24 rises above or falls below an order of magnitude which can be set by design, the membrane 22 hits one of the stops 26, 28 and is thus protected from mechanical damage or overload.

According to the invention, a third pressure chamber 30 is provided which is connected via a pressure-medium connection 32 to the inlet 14 and the first pressure chamber 20. The pressure-medium connection 32 bypasses the second pressure-medium chamber 24, and like the first pressure chamber 20 is filled with non-compressible brake fluid. Downstream of its branch from the inlet 14, the pressure-medium connection 32 is fitted with a hydraulic resistance 34, e.g. a choke or diaphragm. The third pressure chamber 30 surrounds the second pressure chamber 24 both on its peripheral side and on one of its two end faces. To separate the different media of the second pressure chamber 24 and third pressure chamber 30, a pot-like, elastically deformable, hollow-bodied damping element 36 is provided which is configured for example as a bellows element. This receives the second pressure chamber 24 in its interior. Instead of a bellows element, for example a bladder-like damping element could be provided. The open end of the hollow-bodied damping element 36 is attached to the mechanical stop 26 for the membrane 22. This membrane 22 bridges the second end face of the second pressure chamber 24. The membrane 22 and the hollow-bodied damping element 36 together form a separating device 40 which separates the second pressure chamber 24 from the first pressure chamber 20 and from the third pressure chamber 30, but nonetheless allows the second pressure chamber 24 to be pressurized with the pressure of the third pressure chamber 30 and the pressure of the first pressure chamber 20.

The hydraulic pressure of the inlet 14 or first pressure chamber 20 is transmitted to the third pressure chamber via the pressure-medium connection 32 with the integral hydraulic resistance 34, and acts on the second pressure chamber 24 filled with compressible medium via the pot-like, elastically deformable, hollow-bodied damping element 36. Depending on the respective pressure conditions, in this way the pneumatic preload pressure acting on the membrane 22 is increased or reduced and adapted to the system pressure of the inlet 14. The membrane 22 therefore assumes its neutral position within its installation space, since the pneumatic forces acting thereon from the second pressure chamber 24 essentially balance the opposing hydraulic forces from the first pressure chamber 20. Almost the entire, structurally possible deflection is therefore available to the membrane 22 for damping the pressure fluctuations in both spatial directions.

The second pressure chamber 24 filled with compressible fluid is thus pressurized by two different routes, wherein these routes differ in their choke effect. The first route is unchoked. It comprises the first pressure chamber 20 and is limited by the membrane 22. Due to the mechanically limited deflection of the membrane 22, the first route allows only the displacement or absorption of a small pressure-medium volume in the first pressure chamber 20.

The second route is choked and comprises the pressure-medium connection 32 with the integral hydraulic resistance 34, and the third pressure-medium chamber 30 coupled thereto and limited by the elastic, hollow-bodied damping element 36. Because of the deformability of the hollow-bodied damping element 36, the volume of the second route may vary to a very much greater extent than the volume of the first pressure chamber 20, whereby the second route can absorb a larger pressure-medium volume.

Because of the hydraulic resistance 34 of the pressure-medium connection 32, high-frequency or rapid pressure fluctuations are propagated not directly, but only with a time delay into the third pressure chamber 30. Such pulsations first propagate into the first pressure chamber 20 where they cause the deflection of the membrane 22 and are effectively damped by the volume elasticity of the compressible medium enclosed in the second pressure chamber 24. Damping thus takes place via the unchoked first route, and the damping device 10 only extracts a relatively small volume of hydraulic pressure medium from the entire system, so has a low absorption capacity. Despite the effective damping measure, almost the entire quantity of hydraulic pressure medium thus remains available to the connected hydraulic system and therefore ensures a sufficiently good pressure build-up dynamic for the vehicle brake system for unexpected emergency braking situations.

Via the choked second route, the pneumatic preload force of the membrane 22 can be adapted to the system pressure in the inlet 14. The necessary displacement of a large quantity of brake fluid into the third pressure chamber 30 remains possible via the second route described above. Since this route is equipped with a hydraulic resistance 34, the adaptation to the modified pressure in the inlet 14 only takes place however with a time delay. The adaptation of the pneumatic preload force of the membrane to the pressure in the inlet 14 also allows the damping of pressure pulsations occurring after a completed pressure adaptation, without having to displace large quantities of pressure medium which would then no longer be available to the remainder of the vehicle brake system, e.g. for braking maneuvers in which a very high pressure buildup dynamic is required, i.e. a large quantity of available pressure medium.

The second exemplary embodiment of the invention according to FIG. 2 is in principle constructed similarly and also functions as described in connection with exemplary embodiment 1, but differs from this in that the separating device 40, in addition to the membrane 22 and the hollow-bodied damping element 36, is also equipped with a second membrane 42 which blocks the first pressure chamber 20 from the surrounding atmosphere. The second membrane 42 separates a fourth pressure chamber 44, which is connected to the first pressure chamber 20 with integral mechanical stop 46, from a fifth pressure chamber 48 connected to atmosphere. The first pressure chamber 20 and the fourth pressure chamber 44 lie opposite each other and can be combined into a single pressure chamber connected to the inlet 14 and outlet 16.

The second membrane 42 is provided because the first membrane 22 is only able to damp pressure fluctuations which lie above the pneumatic preload pressure prevailing in the second pressure chamber 24, since only such pressure fluctuations can cause any deflection of the first membrane 22. The second membrane 42 is therefore designed in its material and/or elasticity and/or dimensions such that it lies precisely on the assigned mechanical stop 46 when the brake fluid of the first pressure chamber 20 stands just below the preload pressure of the second pressure chamber 24. If a lower pressure prevails in the first pressure chamber 20, the pulsation oscillations occurring cause a deflection of the second membrane 42 in the direction towards atmosphere, and can hence also be damped.

In the third exemplary embodiment according to FIG. 3, the second pressure chamber 24 is filled not with compressible medium but with the same hydraulic fluid as the first pressure chamber 20, whereas the third pressure chamber 30 does not contain brake fluid but a compressible medium, preferably a gas, under a preload pressure. The membrane 22 of the separating device 40 thus no longer serves to separate two media, and can therefore be equipped with a choke or a diaphragm via which a fluid exchange can take place between the first pressure chamber 20 and the second pressure chamber 24. The choke thus allows a pressure balance between the two pressure chambers 20 and 24 and hence corresponds functionally to the hydraulic resistance 34 in the pressure-medium connection 32 of the first exemplary embodiment (FIG. 1). Larger displacements of pressure medium are here absorbed by the second pressure chamber 24, which is located inside the elastic hollow-bodied damping element 36, for example also configured as a bellows element.

Advantageously, due to the mutual exchange of media between the second pressure chamber 24 and the third pressure chamber 30, in comparison with the exemplary embodiment in FIG. 1, now in this third exemplary embodiment according to FIG. 3 there is no need for a separately configured pressure-medium connection, which in particular saves construction space and machining costs for production of the damping device 10 on a housing block of a hydraulic assembly. The separating device 40 comprises, as before, an open and elastically deformable, hollow-bodied damping element 36, preferably in the form of a bellows, to separate the second pressure chamber 24 from the third pressure chamber 30. However, here the third pressure chamber 30 is filled with compressible medium, preferably gas, under a preload pressure. This preload pressure may be selected application-specific and in this third exemplary embodiment no longer preloads the membrane 22 of the separating device 40 but rather the hollow-bodied damping element 36.

In their function, the exemplary embodiments according to FIGS. 1 and 3 are identical, so that in this respect reference may be made to the corresponding statements in connection with FIG. 1.

FIG. 4 shows the embodiment according to FIG. 1 but with the change that the line 12 carrying brake fluid, to which the damping device 10 is connected, is no longer formed continuously but is divided into an inlet 14 and a separate outlet 16. The inlet 14 and outlet 16 open into the first pressure chamber 20 physically separated from each other, and are oriented substantially vertically to the extension direction of the membrane 22. Such an orientation of the inflowing and outflowing pressure medium promotes the damping effect of the membrane 22. Separate inlets 14 and outlets 16, oriented vertically to the extension direction of the membrane 22, may be transferred to all three exemplary embodiments described above.

Finally, FIG. 5 shows a hydraulic circuit diagram of a brake circuit 50 of the vehicle brake system which is equipped with one of the damping devices 10 described above. As an example, the damping device 10 according to the exemplary embodiment in FIG. 1 is shown. The brake circuit 50 depicted is connected to a driver-actuatable brake master cylinder 52 and comprises a wheel brake 54. A pressure-medium connection from the brake master cylinder 52 to the wheel brake 54 can be blocked by an electronically controllable changeover valve 56 if it is necessary to isolate the brake master cylinder 52 and hence the driver from the wheel brake 54. Downstream of the changeover valve 56, an inlet valve 58 is also arranged in the brake circuit 50 and, together with an outlet valve 60 also connected to the wheel brake 54, allows modulation of the pressure in the wheel brake 54.

Pressure medium flowing out of the wheel brake 54 flows to a pressure generator 62, preferably a piston pump, which can be driven by a drive motor 64. The pressure generator 62 delivers pressure medium from the wheel brake 54, via the damping device 10 according to the invention, back into the brake circuit 50, wherein the delivery point into the brake circuit 50 is located between the changeover valve 56 and the inlet valve 58.

If the quantity of pressure medium which can be delivered by the wheel brake 54 is not sufficient e.g. to raise the pressure in the wheel brake 54 to the necessary pressure level, the pressure generator 62 may be connected directly to the brake master cylinder 52 via a high-pressure changeover valve 66, and then the pressure generator 62 can aspirate directly from the brake master cylinder 52.

All valves 56, 58, 60, 66 shown are 2/2-way directional valves which can be switched electromagnetically between a passage and a blocked position. In particular for valves 56 and/or 66, it is possible to configure these as proportional valves so that they can assume any intermediate position.

Apart from the brake master cylinder 52 and the wheel brake 54, all other components of the brake circuit 50 described are arranged on a hydraulic block of a hydraulic assembly of a vehicle brake system. The hydraulic block is provided with bores which form the receivers for these components. Such a hydraulic block can be configured or equipped particularly compactly and economically if the pressure generator 62 with the damping device 10 is arranged in a common receiver of the hydraulic block.

Evidently, further changes may be made to the exemplary embodiments described without deviating from the basic concept of the invention claimed in the claims.

1. A damping device, including a structure that defines:
an inlet and an outlet configured to supply pressure medium to the damping device;
a first pressure chamber connected to the inlet and to the outlet;
a second pressure chamber configured to receive a compressible medium;
a third pressure chamber having a pressure level; and
the damping device further including:
a separating device positioned between the first pressure chamber and the second pressure chamber and configured to separate the third pressure chamber from the second pressure chamber and enable pressurization of the second pressure chamber with the pressure level of the third pressure chamber; and
a pressure-medium connection that has an integral resistance and that connects to the first pressure chamber to the third pressure chamber.

2. The damping device according to claim 1, wherein the separating device includes at least one elastically deformable membrane.

3. The damping device according to claim 1, wherein the separating device includes an elastically deformable, hollow-bodied damping element.

4. The damping device according to claim 2, wherein the separating device includes at least one mechanical stop configured to act as a stop for the membrane.

5. The damping device according to claim 2, wherein the separating device further includes a second membrane that is configured to block the first pressure chamber from an atmosphere.

6. The damping device according to claim 1, wherein:
the inlet and the outlet each open into the first pressure chamber; and
the inlet and the outlet are separate from each other.

7. The damping device according to claim 6, wherein:
the separating device includes at least one elastically deformable membrane; and
the inlet and the outlet each open into the first pressure chamber in a substantially perpendicular direction relative to an extension direction of the membrane of the separating device.

8. A slip-controllable vehicle brake system comprising:
at least one brake circuit including:
a wheel brake;
a pressure generator; and
at least one damping device arranged hydraulically downstream of the pressure generator the at least one damping device including a structure that defines:
an inlet and an outlet configured to supply pressure medium to the damping device;
a first pressure chamber connected to the inlet and to the outlet;
a second pressure chamber filled with a compressible medium;
a third pressure chamber having a pressure level; and
the damping device further including:
a separating device positioned between the first pressure chamber and the second pressure chamber and configured to separate the third pressure chamber from the second pressure chamber and enable pressurization of the second pressure chamber with the pressure level of the third pressure chamber; and
a pressure-medium connection that has an integral resistance and that connects the first pressure chamber to the third pressure chamber.

9. The slip-controllable vehicle brake system according to claim 8, further comprising a hydraulic assembly that includes a housing block having a plurality of receivers positioned on the housing block and configured to receive at least a portion of the brake circuit; and
wherein the pressure generator and the at least one damping device are positioned in a common receiver.
